(19) United States
(12) Patent Application Publication
(10) Pub. No.: US 2002/0125421 A1
(43) Pub. Date: Sep. 12, 2002

(54) Mass spectrometer

(76) Inventors: Kiyomi Yoshinari, Hitachi (JP); Yoshiaki Kato, Mito (JP)

Correspondence Address: DICKSTEIN SHAPIRO MORIN & OSHINSKY LLP, 2101 L STREET NW, WASHINGTON, DC, 20037-1526, US

(21) Appl. No.: 10/080,395

(22) Filed: Feb. 25, 2002

(30) Foreign Application Priority Data
Mar. 6, 2001 (JP) 2001-061532

(51) Int. Cl. H01J 49/00

(52) U.S. Cl. 250/281; 250/292; 250/288

(57) ABSTRACT

In the ion transport system for transporting ions from the ion source to the mass spectrometer, the multipole ion guide for transmitting ions necessary for analysis highly efficiently and eliminating unwanted ions before arriving at the mass spectrometer is realized.

The mass spectrometer has the ion source for ionizing a specimen, the ion transport system using the multipole radio frequency electric field more than the quadrupole electric field, the ion injection unit for injecting ions passing through the transport system into the mass spectrometer, the mass spectrometer for separating and analyzing ions by the mass-to-charge ration of the ions, and the detector for detecting ions subjected to mass spectrometric analysis.

The mass spectrometer has the control means for changing the multipole electric field of radio frequency generated in the transport system according to the mass-to-charge ratio of ions passing through the transport system.

### BACKGROUND OF THE INVENTION

1. Field of the Invention

The present invention relates to a mass spectrometer having an ion transport art for transmitting analytical ions highly efficiently and eliminating unwanted ions highly efficiently.

2. Prior Art

Firstly, an ion transport system of a mass spectrometer will be explained.

In the mass spectrometer for ionizing a specimen by other than a mass spectrometer, an ion transport system is generally installed between an ion source for generating ions and a mass spectrometer for analyzing the mass of generated ions.

The electrode constitution of the ion transport system is broadly divided into a static electric lens constitution and use of a radio frequency electric field of multipole. Generally, the latter is a multipole ion guide composed of an electrode system that four or more even-numbered rod-shaped electrodes are arranged in parallel.

FIGS. 2(a) and 2(b) show cases that four and eight rod-shaped electrodes are arranged in parallel. To each adjacent rod-shaped electrodes, as shown in FIGS. 2(a) and 2(b), radio frequency voltages ±Vₘᵤₗcos (Ωₘᵤₗt) are applied so that the signs are inverted and in the space between the rod-shaped electrodes, a radio frequency multipole electric field is generated. Ions oscillate and pass through the radio frequency electric field.

The multipole ion guide can stably transport ions for a comparatively long distance and further when the degree of vacuum is low, improvement of the energy convergence can be expected, so that the guide is adopted by many mass spectrometer.

In a conventional multipole ion guide system, the radio frequency voltage to be applied to the multipole is kept constant and not set movable. For example, in Japanese Application Patent Laid-Open Publication No. Hei 2-276147, the energy of ions when they are injected into the multipole ion guide is controlled, while the applied voltage to the multipole electrode is not controlled.

### SUMMARY OF THE INVENTION

### Problems to be Solved by the Invention

An object of the present invention is to provide a mass spectrometer having a multipole ion guide, in an ion transport system for transporting ions from the ion source to the mass spectrometer, for transmitting ions necessary for analysis highly efficiently and eliminating unwanted ions before arriving at the mass spectrometer.

### Means for Solving the Problems

The present invention accomplishes the above object basically by use of the constitution indicated below in a mass spectrometer having the aforementioned ion transport system using a multipole electric field of radio frequency.

According to the mass-to-charge ratio (mass number) range of ions necessary to mass spectrometric analysis and the mass-to-charge ratio (mass number) of unwanted ions which may be a noise source, the multipole electric field generated in the multipole ion guide is changed.

### BRIEF DESCRIPTION OF THE DRAWINGS

FIG. 1 is a whole schematic block diagram of a mass spectrometer relating to an embodiment of the present invention,

FIG. 2 is a schematic perspective view of a multipole ion guide,

FIG. 3 is a schematic explanatory diagram when an octopole electrode system is used as a multipole ion guide used in the aforementioned embodiment,

FIG. 4 is an illumination showing numerical analytical results of injection position dependence of ions into the octopole electrode system of the oscillation amplitude A when oscillating and passing the octopole electrode system,

FIG. 5 is an illumination showing numerical analytical results concerning the amplitude Vₘᵤₗ dependence of the radio frequency voltage Vₘᵤₗcos (Ωₘᵤₗt) applied to the rod electrode of the stable oscillation amplitude A of ions,

FIG. 6 is an illumination showing numerical analytical results concerning the frequency Ωₘᵤₗ/2π dependence of the radio frequency voltage Vₘᵤₗcos (Ωₘᵤₗt) applied to the rod electrode of the stable oscillation amplitude A of ions,

FIG. 7 is a characteristic diagram of numerical analytical results showing the relation between the ion parameter q value and the relative value Rb/rₒ of the stable transmission beam diameter Rb to rₒ,

FIG. 8 is a flow chart showing the first control state of the ion transport system in the aforementioned embodiment,

FIG. 9 is a flow chart showing the second control state of the ion transport system in the aforementioned embodiment,

FIG. 10 is an illustration showing the relation between the ion parameter q value in a broken line state in (a) and in a step state in (b) and the relative value Rb/rₒ of the stable transmission beam diameter Rb to rₒ,

FIG. 11 is a schematic view when a quadruple-pole electrode system is used as a multipole ion guide used in the aforementioned embodiment,

FIG. 12 is a time chart showing the fourth control state of the ion transport system in the aforementioned embodiment,

FIG. 13 is a time chart showing the fourth control state of the ion transport system in the aforementioned embodiment,

FIG. 14 is a time chart showing the fifth control state of the ion transport system in the aforementioned embodiment,

FIG. 15 is a time chart showing the fifth control state of the ion transport system in the aforementioned embodiment,

FIG. 16 is a schematic view of the mass spectrometer when an ion trap type mass spectrometer is adopted in the embodiment shown in FIG. 1,

FIG. 17 is a schematic view of the whole mass spectrometer when a quadrupole mass spectrometer is adopted in the embodiment shown in FIG. 1, and

FIG. 18 is a schematic view of the whole mass spectrometer when a time of flight mass spectrometer is adopted in the embodiment shown in FIG. 1.

### DETAILED DESCRIPTION OF THE INVENTION

### Description of the Preferred Embodiments

The embodiments of the present invention will be explained hereunder with reference to the accompanying drawings.

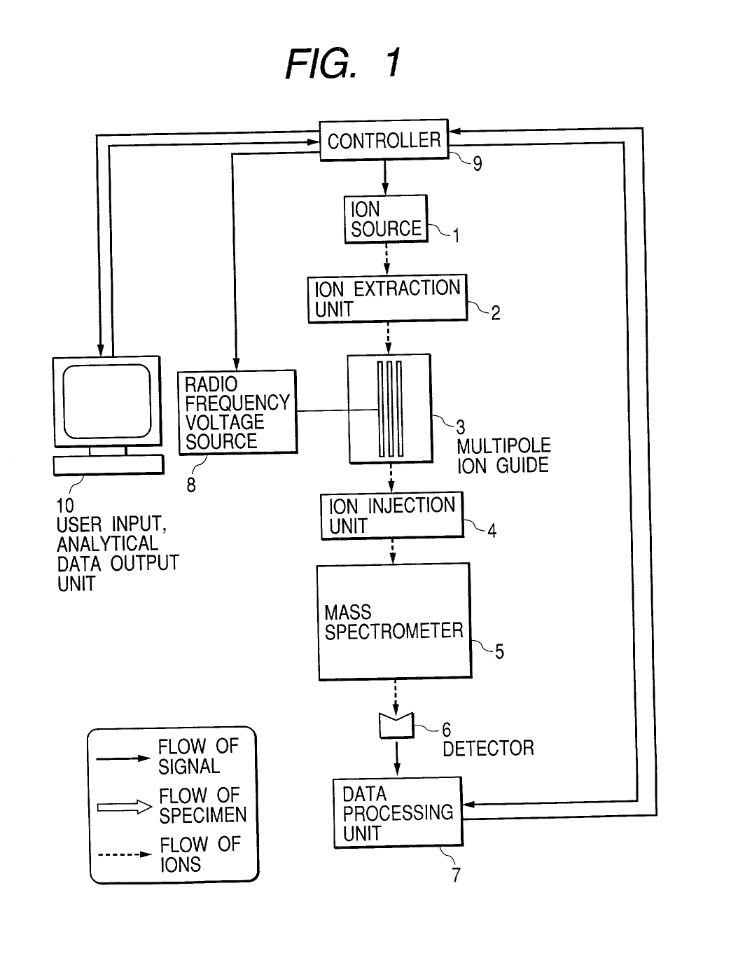

FIG. 1 is a whole schematic block diagram of a mass spectrometer relating to an embodiment of the present invention.

A specimen (mixture) which is an object of mass spectrometric analysis is ionized in an ion source 1 and ions generated there are accelerated by an ion extraction unit 2, pulled out from the ion source 1, and pass a multipole ion guide 3 which is an ion transport system. Thereafter, ions are introduced into a mass spectrometer 5 via an injection unit 4.

A user sets and inputs the mass-to-charge ratio of ions to be analyzed in a user input unit 10. The mass spectrometer 5 executes mass separation of ions on the basis of the mass-to-charge ratio range of ions to be analyzed which is input by the user.

The mass-separated ions are ejected outside the mass spectrometer 5, detected by a detector 6, and processed by a data processing unit 7.

In a series of mass spectrometric analysis processes, a controller 9 executes various control and adjustment necessary for mass spectrometric analysis such as ionization of a specimen, control of the applied voltages to the ion extraction unit and multipole ion guide, transport of the ion beam, and injection control into the mass spectrometer, and further executes control of the data processing unit, thereby controls the whole mass spectrometric analysis processes.

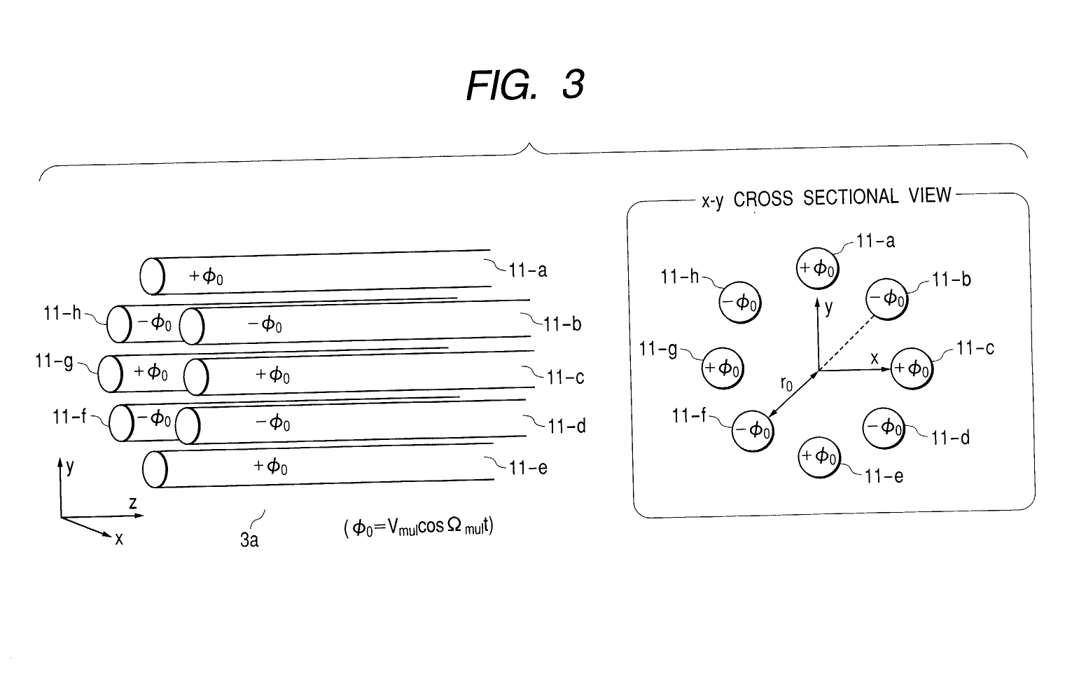

In this embodiment, as a multipole ion guide 3, an octopole electrode system 3a that 8 rod-shape electrodes 11-a, b, c, d, e, f, g, and h as shown in FIG. 3 are arranged in parallel is adopted.

To each rod-shaped electrode, the radio frequency voltage Vₘᵤₗcos (Ωₘᵤₗt) is applied from a radio frequency voltage power source 8. In this case, to the adjacent rod electrodes, the radio frequency voltage Vₘᵤₗcos (Ωₘᵤₗt) is applied so that the sign thereof is inverted. For example, to the rod-shaped electrodes 11-a, c, e, and g, +Vₘᵤₗcos (Ωₘᵤₗt) is applied and to the rod-shaped electrodes 11-b, d, f, and h, −Vₘᵤₗcos (Ωₘᵤₗt) is applied. At this time, in the octopole electrode, a radio frequency electric field (multipole electric field) theoretically indicated by the following formula is generated.

[Formula 2]

Eₓ=−4·Vₘᵤₗcos(Ωₘᵤₗt)·x(x²−3y²)/rₒ⁴

E_{y}=−4·Vₘᵤₗcos(Ωₘᵤₗt)·y(y²−3x²)/rₒ⁴

where rₒ indicates a half value of the distance between the opposite rod electrodes and x and y indicate ion coordinates from the central position of the octopole electrode on the plane orthogonally intersecting the octopole electrode system (FIG. 3). Ions pass in the longitudinal direction (z direction) of the rod electrodes with oscillating in such a radio frequency electric field, are introduced into the mass spectrometer 5 by the ion injection unit 4, and subjected to mass spectrometric analysis.

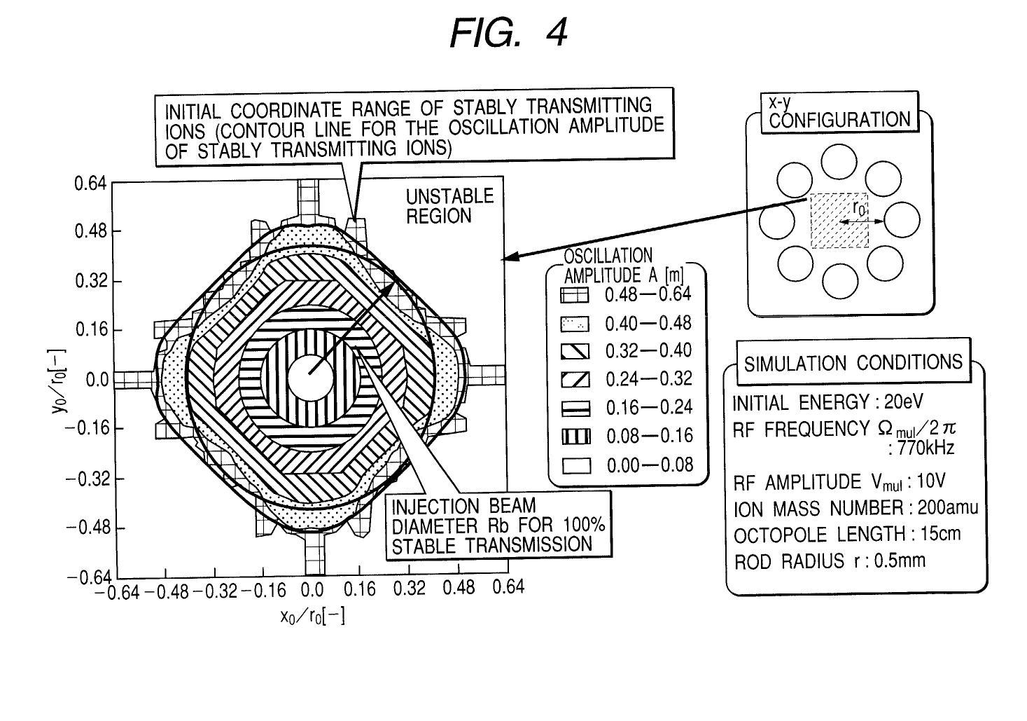

Here, the results obtained by numerical analysis of the dependence of the ion position at the time of injection of ions into the octopole electrode system 3a of the oscillation amplitude A when monovalent positive ions of an ion mass number of 200 amu oscillate and pass in the octopole electrode system 3a are shown in FIG. 4. The used simulation conditions are shown in FIG. 4 at the same time.

As the injection position of ions into the octopole electrode system 3a is separated from the center, the stable oscillation amplitude A increases. Furthermore, when the injection position of ions is separated almost 0.43 rₒ or more from the center, the ion oscillation amplitude A becomes zero, that is, exceeds the distance rₒ between the rod electrodes and ions become unstable and are ejected outside the octopole electrode system 3a.

Therefore, to enable ions in the ion beam to pass the octopole electrode system 3a perfectly stably, ions must be converged so that the radius of the ion beam (ion beam diameter) becomes smaller than 0.43 rₒ at the time of injection into the octopole electrode system 3a. Hereafter, the beam diameter that ions in the beam can transmit perfectly stably is referred to as a stable transmission beam diameter Rb. Hereafter, the ion valency number is basically assumed as 1 (Z=1). Namely, a relation of m/Z=m is obtained and “mass-to-charge ratio m/Z” and “ion mass m” have the same meaning.

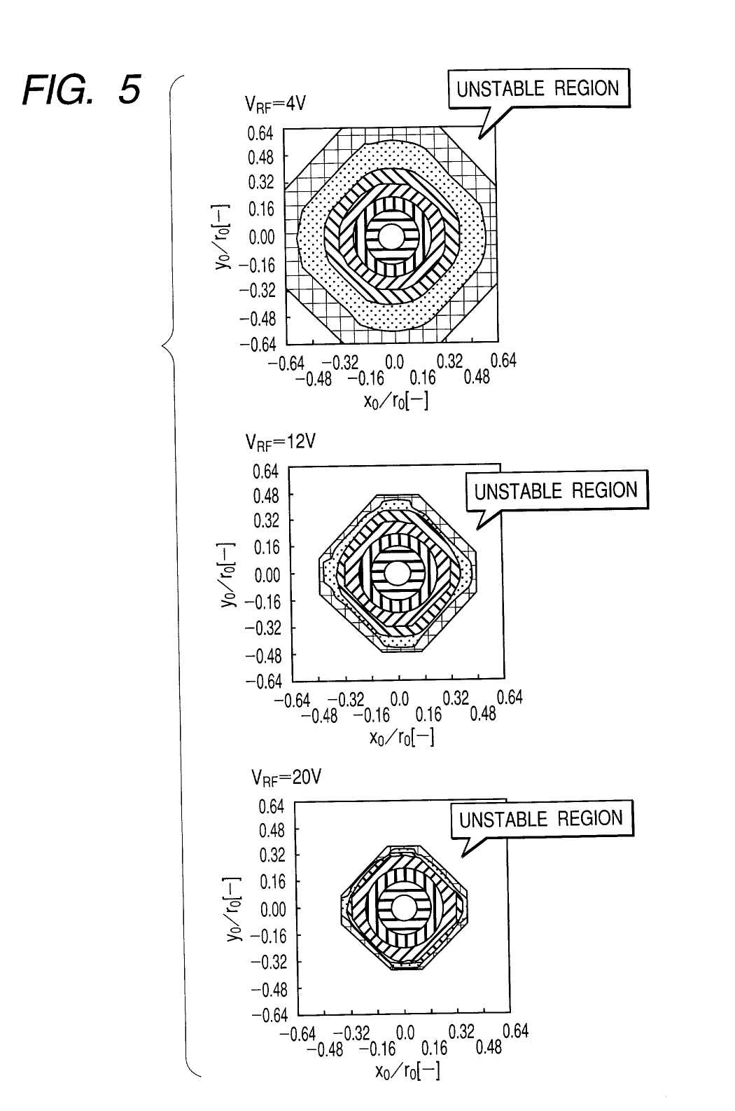

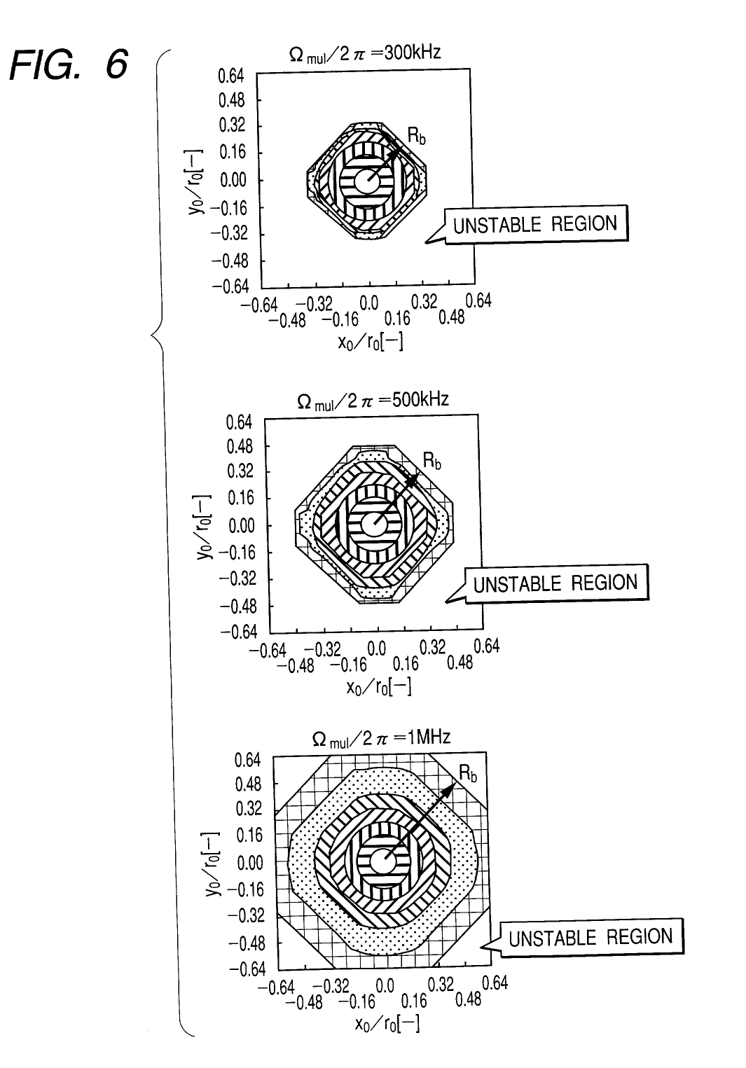

In the same way, the results of the stable oscillation amplitude A of ions obtained by changing the amplitude Vₘᵤₗ of the radio frequency voltage Vₘᵤₗcos (Ωₘᵤₗt) to be applied to the rod electrodes are shown in FIG. 5. The legend concerning the region of the stable transmission beam diameter shown in FIG. 4 is common to FIGS. 5 and 6. As the amplitude Vₘᵤₗ of the radio frequency voltage increases, the stable transmission beam diameter Rb is reduced.

Furthermore, the dependence of the ion stable oscillation amplitude A on the frequency Ωₘᵤₗ/2π of the radio frequency voltage Vₘᵤₗcos (Ωₘᵤₗt) to be applied to the rod electrodes is checked. The results are shown in FIG. 6. As the frequency Ωₘᵤₗ/2π of the radio frequency voltage increases, the stable transmission beam diameter Rb increases. This is a reverse relation to the relation between the stable transmission beam diameter Rb and the amplitude Vₘᵤₗ of the radio frequency voltage. Next, for the ion parameter q value defined by the following formula, the dependence of the stable transmission bear diameter Rb on the q value is checked.

[Formula 3]

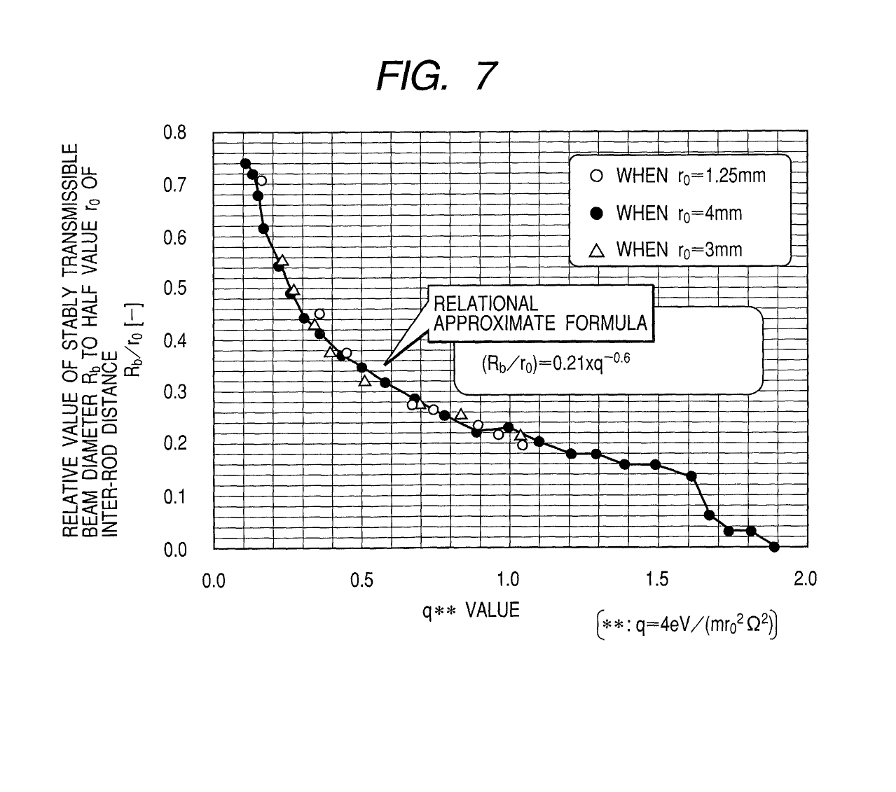

q=4eZVₘᵤₗ/(mrₒ²Ωₘᵤₗ²)

where e indicates an elementary charge, and m/Z indicates a mass-to-charge ratio of ions, and Ωₘᵤₗ indicates an angular frequency, and the amplitude Vₘᵤₗ of the radio frequency voltage and the frequency Ωₘᵤₗ/2π of the radio frequency voltage are in an inverse relation to the q value. The radius Rb of the ion beam transmitted stably which is obtained by numerical analysis when the q value is changed is shown in FIG. 7.

It is found that as the q value is reduced, the relative value Rb/rₒ of the stable transmission beam diameter Rb to rₒ approaches 1. In other words, as the q value is reduced, even when the convergence of the ion beam at the time of injection into the octopole electrode system 3a is bad, the ion beam can pass stably through the octopole electrode system 3a. Namely, this means that as the q value is reduced, the stable transmissivity of ions does not depend on the ion position at the time of injection into the octopole electrode system 3a. The relation obtained by numerical analysis shown in FIG. 7 is expressed by the following approximate formula.

[Formula 4]

Rb/rₒ=C·q^{-D}(C≈0.21, D≈0.61)

where the constants C and D may be constants satisfying C≦1 and D<1, though it is desirable to set them within the ranges 0.1≦C≦0.4 and 0.3≦D≦0.8.

In the same way, the relation between the q value and the relative value Rb/rₒ of the stable transmission beam diameter Rb to rₒ when the half value rₒ of the distance between the rod electrodes of the octopole electrode system 3a is changed is obtained and plotted in FIG. 7, thus it is found that it is almost the same as the relation before the half value rₒ of the distance between the rod electrodes of the octopole electrode system 3a is changed. Namely, it is found that even when the parameters for deciding the q value (Formula 3), the mass-to-charge ratio of ions m/Z, the half value rₒ of the distance between the opposite rods, the angular frequency Ωₘᵤₗ of the radio frequency voltage, and the amplitude Vₘᵤₗ are different values respectively, if the q values are the same, the relational formula shown in FIG. 7 is almost reproduced.

Therefore, using the relational formula shown in FIG. 7 which is obtained by numerical analysis, in this embodiment, the control indicated below is executed (first control state).

When the range of the mass-to-charge ratio m/Z of ions which are an object of mass spectrometric analysis is from M₁ to Mₙ (M₁<Mₙ), the range of the respective equivalent q values (Formula 3) is q₁ to qₙ (q₁>qₙ). Namely, as the mass-to-charge ratio (mass number) is reduced, the q value is increased and the transmissible beam diameter Rb is minimized (FIG. 7).

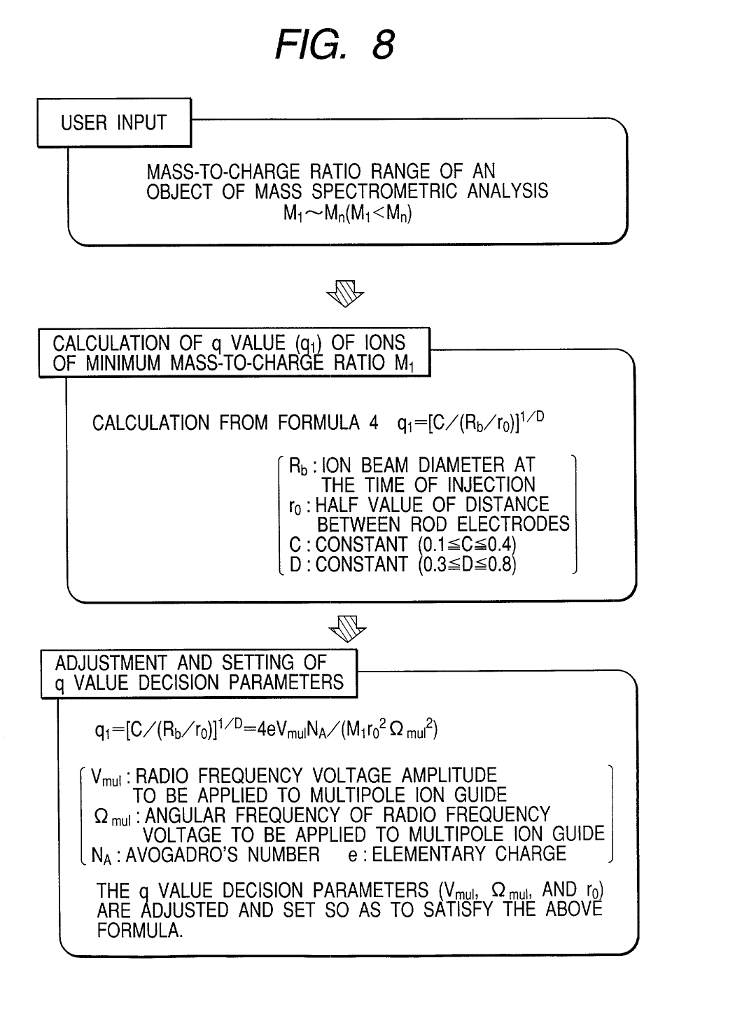

Aiming at ions of a minimum mass number (M₁) that the transmissible beam diameter Rb is minimum and the q value is maximum among ions, which are an object of mass spectrometric analysis, within the mass-to-charge ratio range M₁ to Mₙ (M₁<Mₙ) which is input by a user from the user input unit 10, the q₁ value of ions of a minimum mass number (M₁) that the ion beam can be converged in this case is decided. And, the parameter that the decision value q₁ is obtained for the minimum mass number (M₁) (for example, at least one of the angular frequency Ωₘᵤₗ of the radio frequency voltage and the amplitude Vₘᵤₗ given in Formula 3) is decided and the multipole electric field of the ion transport system is controlled. A conceptual diagram of the control contents and control process is shown in FIG. 8.

For example, when the beam at the time of injection into the octopole electrode system 3a can be converged up to about ⅓ of rₒ, the q value when Rb/rₒ=0.33 is about 0.6 from the relation shown in FIG. 7, so that to control the q value of ions (M₁) of a minimum mass-to-charge ratio to q₁≦0.6, the respective parameters shown in Formula 3 such as the mass-to-charge ratio m/Z of ions, the half value rₒ of the distance between the opposite rods, the angular frequency Ωₘᵤₗ of the radio frequency voltage, and the amplitude Vₘᵤₗ are adjusted and set.

With respect to the parameters to be adjusted and set, it is possible to change only the amplitude Vₘᵤₗ of the radio frequency voltage or a specific parameter such as the angular frequency Ωₘᵤₗ of the radio frequency voltage and set the q value of ions (M₁) of a minimum mass-to-charge ratio to a value lower than a specific value.

When this setting is made, the parameter q value of other ions having a mass-to-charge ratio m/Z larger than M₁ becomes smaller than q₁ (≦0.6) and the transmissible beam diameter Rb increases more, so that ions can transmit stably. Therefore, according to this embodiment, all ions within the mass-to-charge ratio range which are an object of mass spectrometric analysis can transmit the octopole electrode system stably and highly efficiently and highly sensitive analysis is enabled.

By a mass spectrometer relating to this embodiment, the multipole electric field of the ion transport system can be controlled as indicated below according to the mass-to-charge ratio of ions.

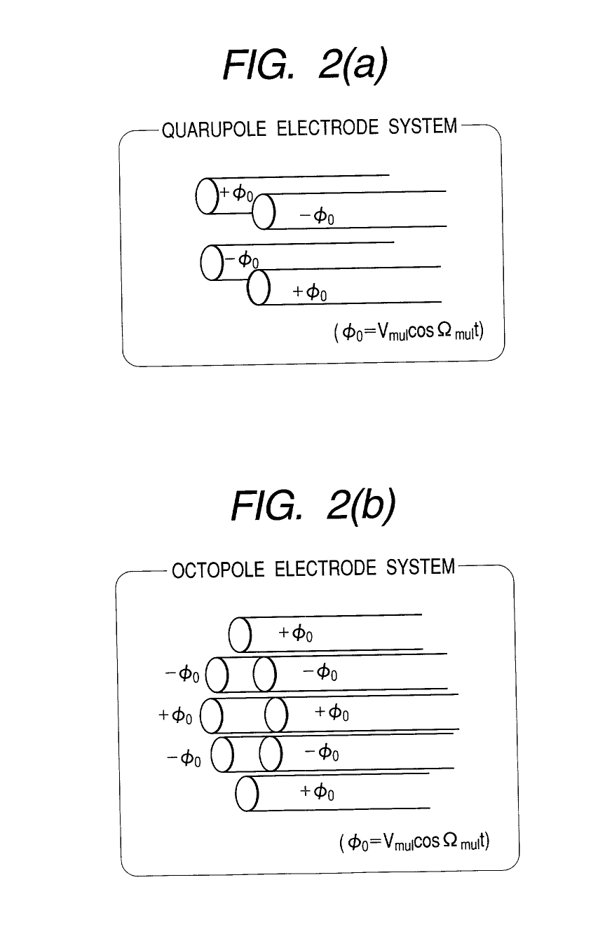

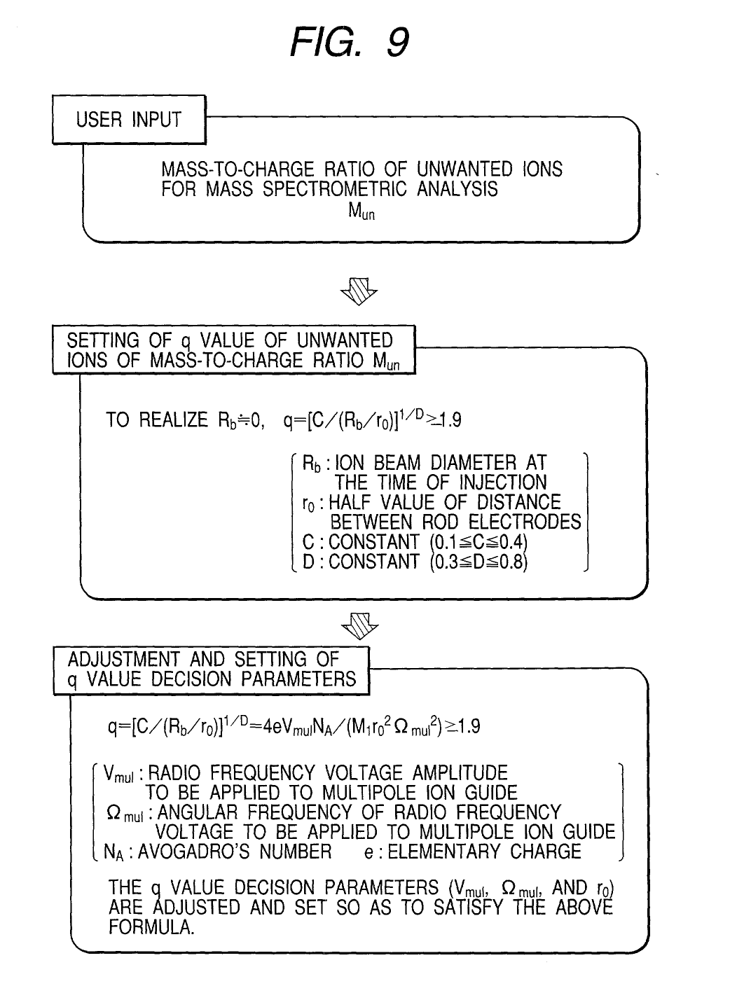

Firstly, the second control state will be explained by referring to FIG. 9. Also in this embodiment, FIGS. 1 to 7 are the same as those of the first embodiment.

As shown by the relation in FIG. 7, the transmissible beam diameter Rb is close to zero when q≈1.9. This means that ions of q≧1.9 cannot all transmit stably.

In this embodiment, using this property, as shown in FIG. 9, to control the q value of unwanted ions (the mass-to-charge ratio is assumed as Mᵤₙ) for mass spectrometric analysis which is input by a user from the user input unit 10 to q≧1.9, the q value decision parameters (the mass-to-charge ratio of ions m/Z, the half value rₒ of the distance between the opposite rods, the angular frequency Ωₘᵤₗ of the radio frequency voltage, and the amplitude Vₘᵤₗ) are adjusted and set.

For example, when the ion source 1 is an ICP (Inductively Coupled Plasma) ion source, Ar⁺ ions flow into the mass spectrometer 5 in large quantities, causing noise. Therefore, when the q value of Ar⁺ ions is set to q≧1.9, Ar⁺ ions which are a noise source can be eliminated in the octopole electrode system 3a at the preceding stage of injection into the mass spectrometer 5 and great reduction of noise can be expected. Therefore, according to this embodiment, unwanted ions can be eliminated highly efficiently before injecting into the mass spectrometer 5, so that it can contribute to great improvement of the SN ratio.

Next, the third control state of the ion transport system by the mass spectrometer of this embodiment will be explained.

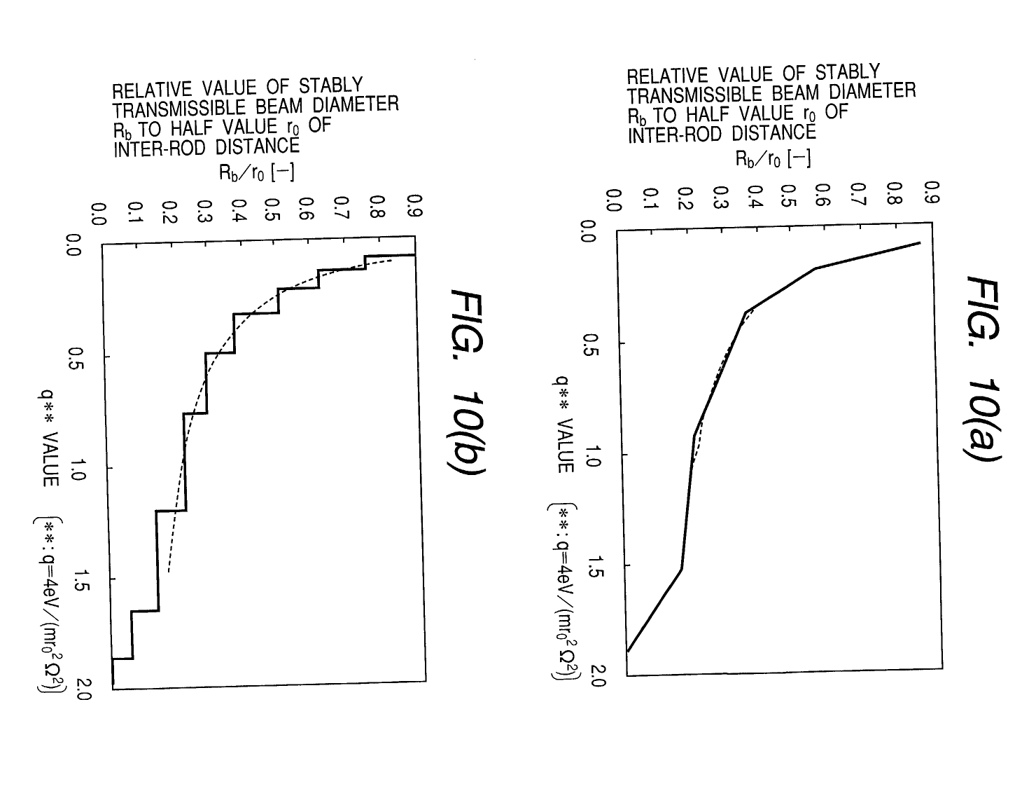

In this case, in place of the first state, the relational formula (property) between the q value and the relative value Rb/rₒ of the stable transmission beam diameter Rb to rₒ shown in FIG. 7 is deformed to a property changed in a broken line state as shown in FIG. 10(a) or to a property changed in a step state as shown in FIG. 10(b). In this case, the relation between the q value and the relative value Rb/rₒ of the stable transmission beam diameter Rb to rₒ is extremely simplified, so that the control for changing the q value according to the mass-to-charge ratio of transmitted ions can be easily executed (for example, q₁ of the first state can be easily obtained).

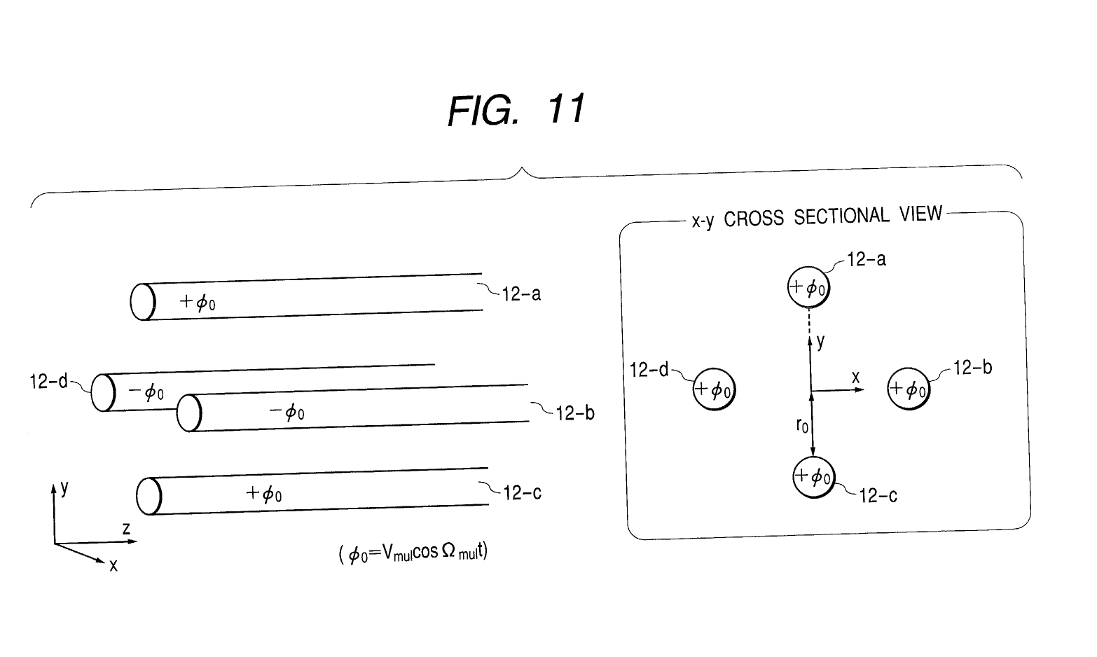

In FIG. 1, the octopole electrode system 3a is used as a multipole ion guide 3. However, in place of it, as shown in FIG. 11, a quadrupole electrode system 3b composed of four rod-shaped electrodes 12-a, b, c, and d arranged in parallel can be used.

In this case, a radio frequency voltage is applied to each of the rod-shaped electrodes 12-a, b, c, and d it is applied so that between the adjacent rod electrodes, the sign of the radio frequency voltage Vₘᵤₗcos (Ωₘᵤₗt) is inverted. For example, to the rod-shaped electrodes 10-a and c, +Vₘᵤₗcos (Ωₘᵤₗt) is applied and to the rod-shaped electrodes 12-b and d, −Vₘᵤₗcos (Ωₘᵤₗt) is applied. At this time, in the quadrupole electrode, a radio frequency electric field theoretically indicated by the following formula is generated.

[Formula 5]

Eₓ=−2·x/rₒ²

E_{y}=+2·y/rₒ²

where rₒ indicates a half value of the distance between the opposite rod electrodes and x and y indicate ion coordinates from the central position of the quadrupole electrode on the plane orthogonally intersecting the quadrupole electrode system (FIG. 11).

As described already, ions pass in the longitudinal direction (z direction) of the rod electrodes with oscillating in such a radio frequency electric field, are introduced into the mass spectrometer 5 by the ion injection unit 4, and subjected to mass spectrometric analysis.

When the range of the mass-to-charge ratio of ions which are an object of mass spectrometric analysis is from M₁ to Mₙ (M₁<Mₙ), the range of the respective equivalent q values (Formula 3) is q₁ to qₙ (q₁>qₙ). Therefore, in this embodiment adopting the quadrupole electrode system 3b, to enable all analytical object ions to transmit through the quadrupole electrode system 3b highly efficiently according to the range (mass range) of mass-to-charge ratio, so as to control the q value (q₁) of ions having a minimum value within the mass range to q₁<0.908, the respective parameters for deciding the q value (formula) (the mass-to-charge ratio m/Z of ions, the half value rₒ of the distance between the opposite rods, the angular frequency Ωₘᵤₗ of the radio frequency voltage, and the amplitude Vₘᵤₗ) are adjusted and set. Further, in this embodiment adopting the quadrupole electrode system 3b, when unwanted ions are to be eliminated by the quadrupole electrode system 3b according to the mass-to-charge ratio of the unwanted ions, the q value of unwanted ions is set to q≧0.9.

As mentioned above, even in this embodiment adopting the quadrupole electrode system 3b, ions necessary for analysis within the mass range can be all transmitted highly efficiently or unwanted ions can be eliminated highly efficiently. Particularly in this embodiment, it is considered that the mass selectivity for elimination of unwanted ions is increased more than a case of use of the octopole electrode system 3a.

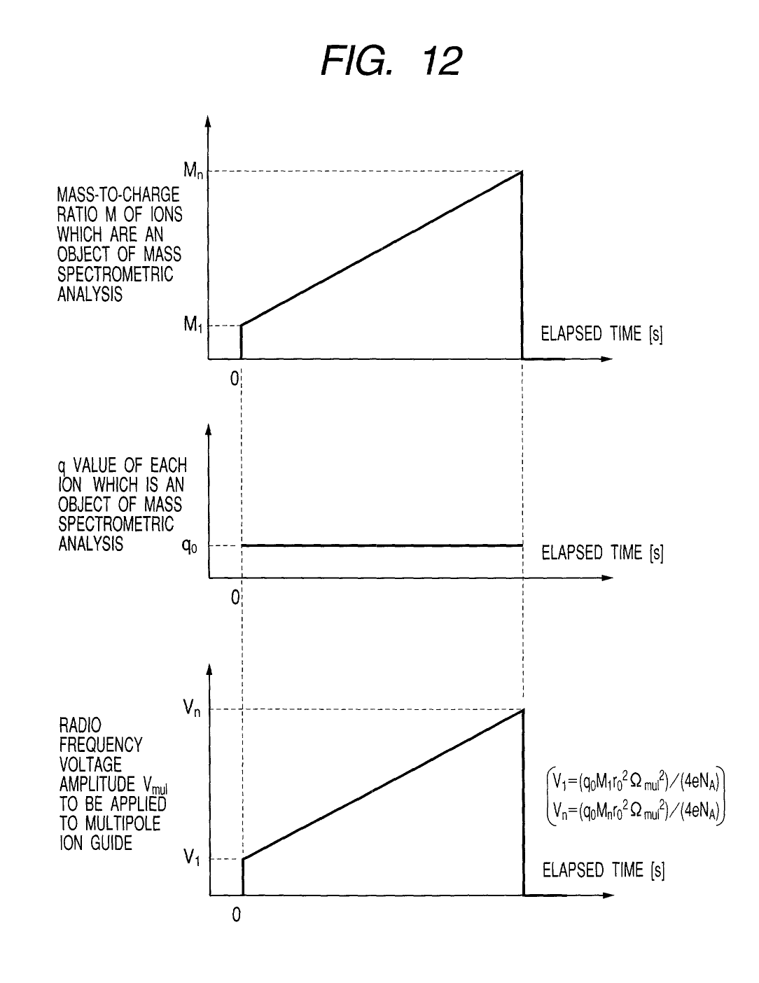

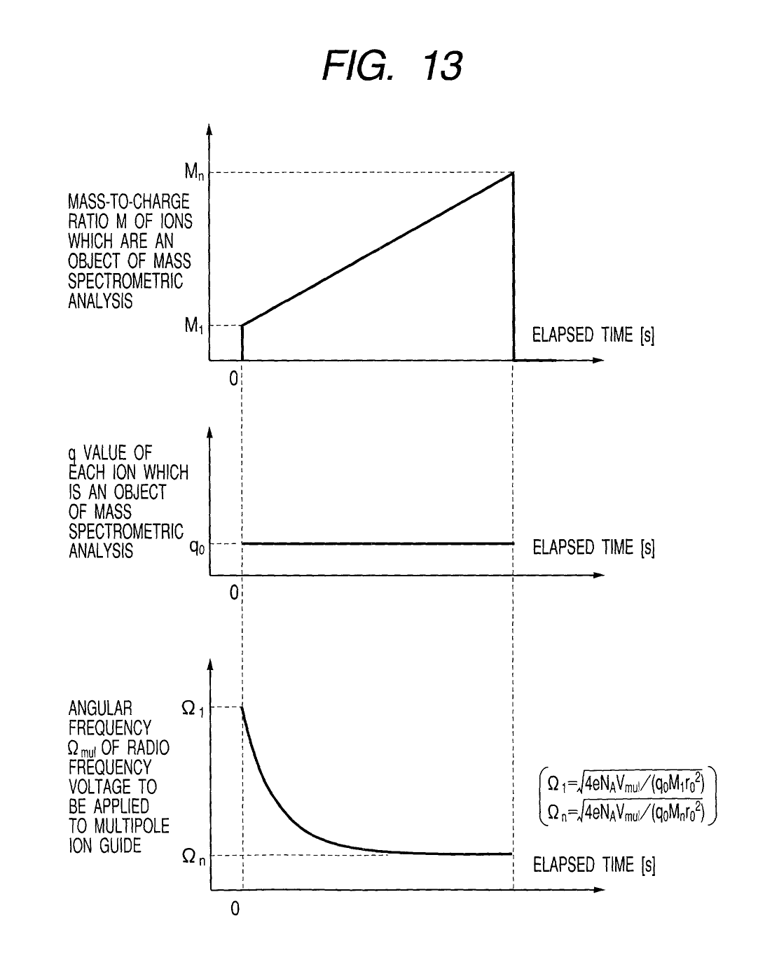

Next, the fourth control state relating to this embodiment will be explained by referring to FIGS. 12 and 13. In the first control state already described, when the range of the mass-to-charge ratio of ions which are an object of mass spectrometric analysis is from M₁ to Mₙ (M₁<Mₙ), with respect to the parameter value q, aiming at the parameter q₁ of the mass number M₁ of the minimum mass-to-charge ratio, on the basis of it, the multipole control parameter (any of the mass-to-charge ratio m/Z of ions, the half value rₒ of the distance between the opposite rods, the angular frequency Ωₘᵤₗ of the radio frequency voltage, and the amplitude Vₘᵤₗ) is decided. Therefore, in the first control state, as the mass number of a specimen of an object of analysis becomes than M₁, the q value is reduced. On the other hand, in this example, as shown in FIG. 12, while the mass spectrometric analysis is scanned (mass spectrometric analysis scan) within the range from M₁ to Mₙ (M₁<Mₙ) of the mass-to-charge ratio of ions which are an object of mass spectrometric analysis, the amplitude Vₘᵤₗ of the radio frequency voltage Vₘᵤₗcos (Ωₘᵤₗt) to be applied to the octopole electrode system 3a (or the quadrupole electrode system 3b) is changed so as to keep the q value constant according to m/Z of the mass number or as shown in FIG. 13, the angular frequency Ωₘᵤₗ (FIG. 12b) is changed according to m/Z of ions of an object of mass spectrometric analysis during mass spectrometric analysis scanning. At this time, when the mass-to-charge ratio m/Z of analytical object ions is scanned linearly for the time, the amplitude Vₘᵤₗ of the radio frequency voltage Vₘᵤₗcos (Ωₘᵤₗt) is also scanned linearly for the time from Formula 3 (FIG. 12). On the other hand, the angular frequency Ωₘᵤₗ of the radio frequency voltage Vₘᵤₗcos (Ωₘᵤₗt) is reduced in proportion to t^{-½} for the time t (FIG. 13). When the radio frequency voltage V ₘᵤₗcos (Ωₘᵤₗt) to be applied to the multipole ion guide 3 is changed whenever necessary according to the mass-to-charge ratio of ions to be subjected to mass spectrometric analysis scanning like this, it can be expected to obtain stable mass spectrometric analysis data that the sensitivity is not affected by the ion species.

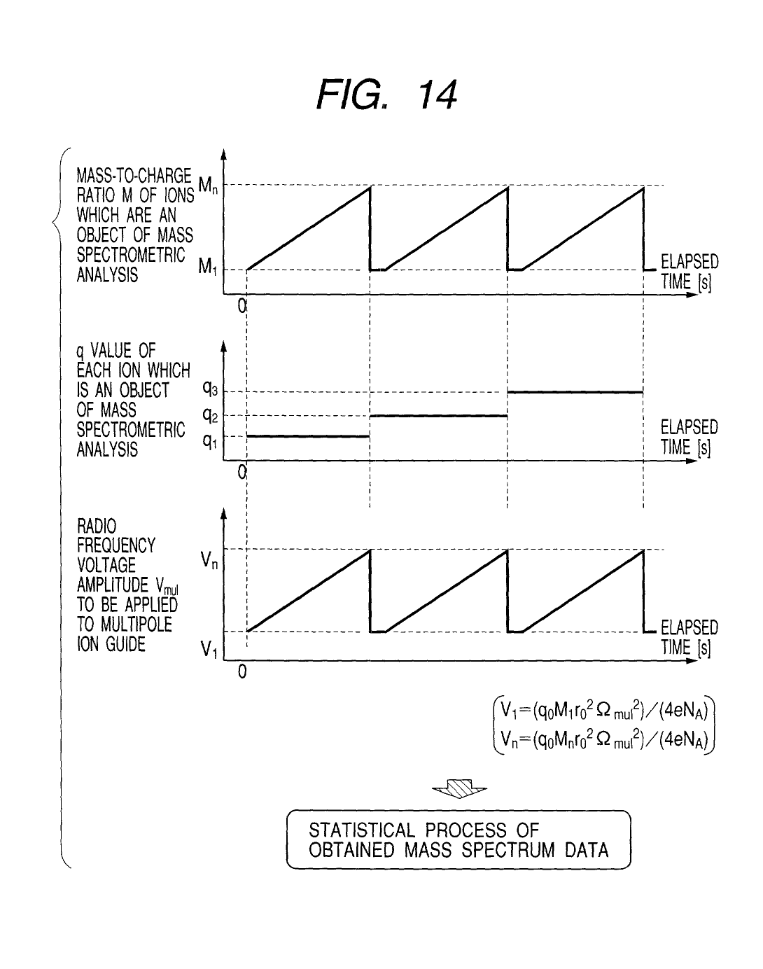

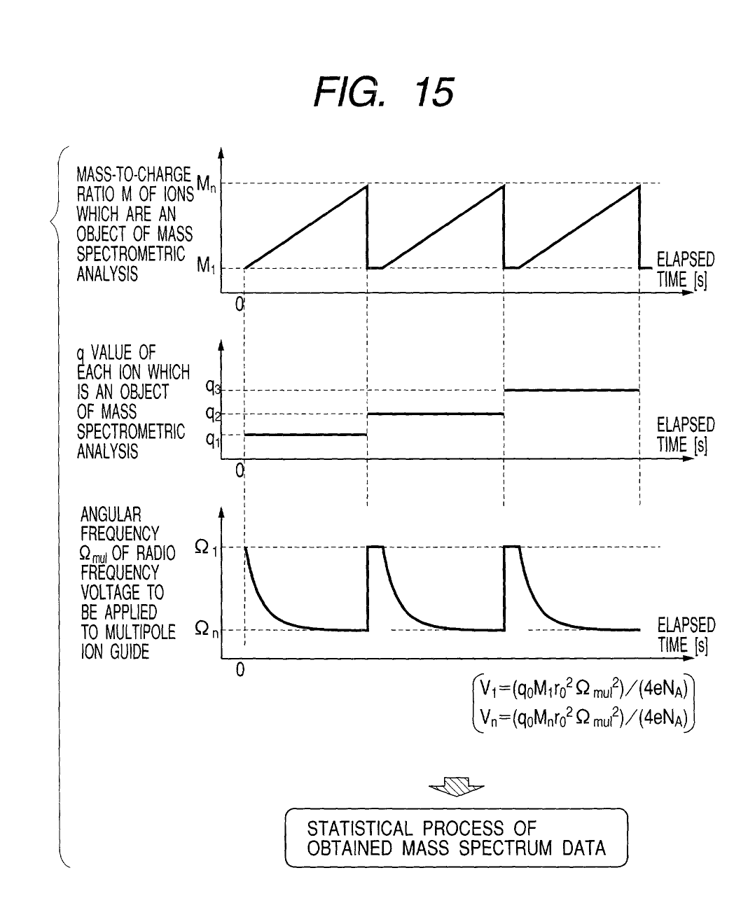

Next, the fifth control state relating to this embodiment will be explained by referring to FIGS. 14 and 15.

In this example, as shown in FIGS. 14 and 15, when ions having a mass-to-charge ratio within a certain specific range from M₁ to Mₙ (M₁<Mₙ) are to be scanned and analyzed, in the same way as with the fourth control state, so as to keep the parameter q value of scan object ions of each mass-to-charge ratio constant, the multipole electric field is changed. However, the mass spectrometric analysis scanning is executed several times. Further, the constant value of the parameter q value is changed for each scanning (q=q1, q2, and q3).

In this case, the control parameter for keeping the q value (q1, q2, and q3) for each scanning constant is at least one of the angular frequency Ωₘᵤₗ of the radio frequency voltage and the amplitude Vₘᵤₗ of Formula 3. In this case, the control state of the amplitude Vₘᵤₗ of the radio frequency voltage Vₘᵤₗcos (Ωₘᵤₗt) is shown in FIG. 14 and the control state of the angular frequency Ωₘᵤₗ is shown in FIG. 15.

During mass spectrometric analysis scanning, the q value set at a constant value is changed for each mass spectrometric analysis scanning, and mass spectrometric analysis data is obtained, and finally the data in correspondence with the mass spectrometric analysis scanning count is subjected to the statistical process. For example, (1) when data slightly different is obtained for each mass spectrometric analysis scanning, the data in correspondence with the mass spectrometric analysis scanning count is averaged. Further, (2) when the data at the time of mass spectrometric analysis scanning when a certain specific q value is set is highly sensitive peculiarly, only the data is adopted as analytical data and hereafter the q value is fixedly analyzed. Inversely, (3) when the data at the time of mass spectrometric analysis scanning when a certain specific q value is set is lowly sensitive particularly, the statistical process is performed excluding the mass spectrometric analysis data. At this time, when a specific q value is set, the deviation of the mass spectrometric analysis data is canceled and stable and accurate mass spectrometric analysis data can be obtained.

For the mass spectrometer 5 (FIG. 1) of this embodiment, various states can be considered.

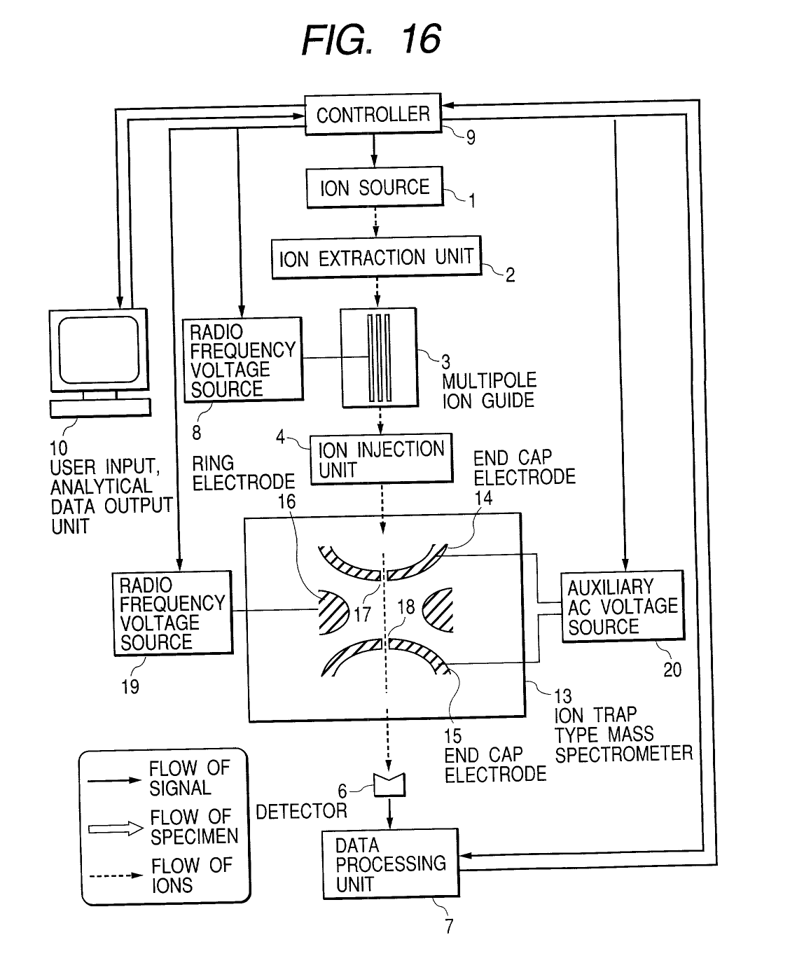

For example, in FIG. 16, an example of an apparatus adopting an ion trap type mass spectrometer 13 as the mass spectrometer 5 shown in FIG. 1 is shown. The ion trap type mass spectrometer 13, as shown in FIG. 16, is composed of two end cap electrodes 14 and 15 which are symmetrical about axis and a ring electrode 16, and between the electrodes, a radio frequency voltage V_{RF}cosΩt is applied by a radio frequency voltage source 19, and a radio frequency electric field is internally generated. However, instead of the radio frequency voltage source 19, the radio frequency voltage source 8 for the multipole guide may be shared. Ions generated by ionizing a specimen in the ion source 1 are accelerated by the ion extraction unit 2, pulled out from the ion source 1, pass through the multipole ion guide 3 which is an ion transport system, then pass through an injection port 17 at the center of the end cap electrode 14 by the ion injection unit 4, and are injected into the ion trap type mass spectrometer 13. In the ion trap type mass spectrometer 13, ions oscillate at an intrinsic oscillation frequency according to each mass-to-charge ratio. Using this respect, in the ion trap process, all ions (M₁ to Mₙ) which are an object of mass spectrometric analysis are trapped once in the ion trap mass spectrometer 13 and an auxiliary AC field generated by applying an auxiliary AC voltage between the two end cap electrodes 14 and 15 and specific ions are resonated and amplified and sequentially detected via an ejection port 18 at the center of the end cap electrode 15. When the ion trap type mass spectrometer 13 is adopted like this embodiment, particularly to collect all ion species once, it is very effective for reduction of noise and improvement of sensitivity to eliminate unwanted ions by the multipole ion guide 3 before injecting them into the mass spectrometer 5 and trap only ions which are an object of mass spectrometric analysis.

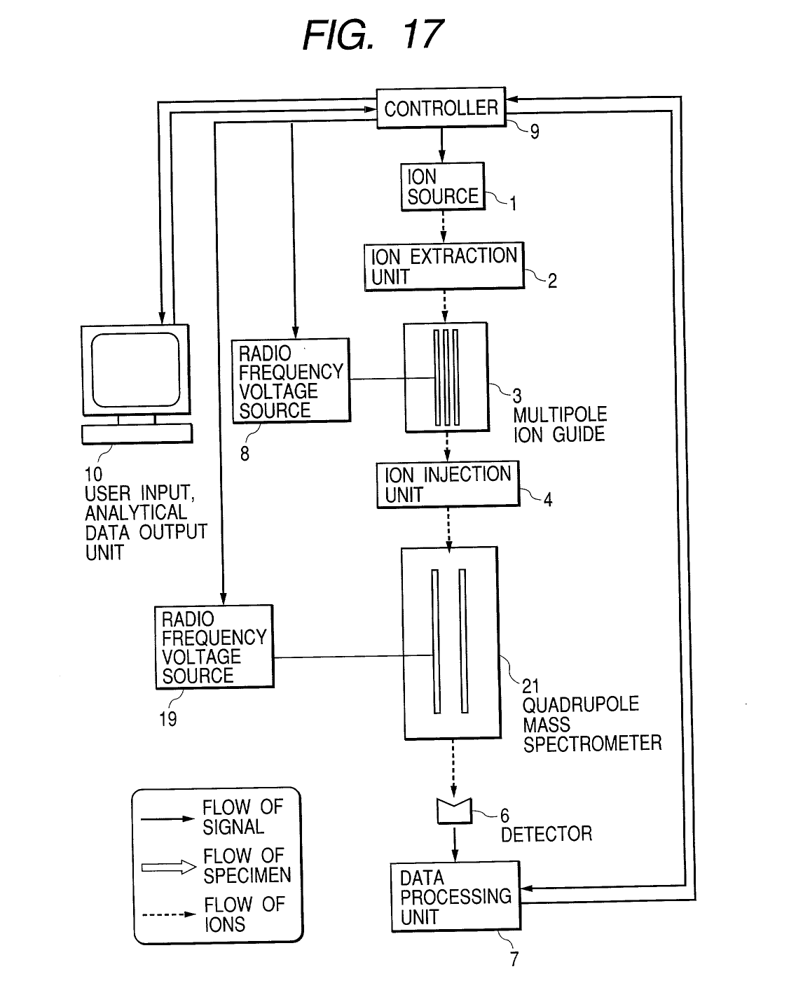

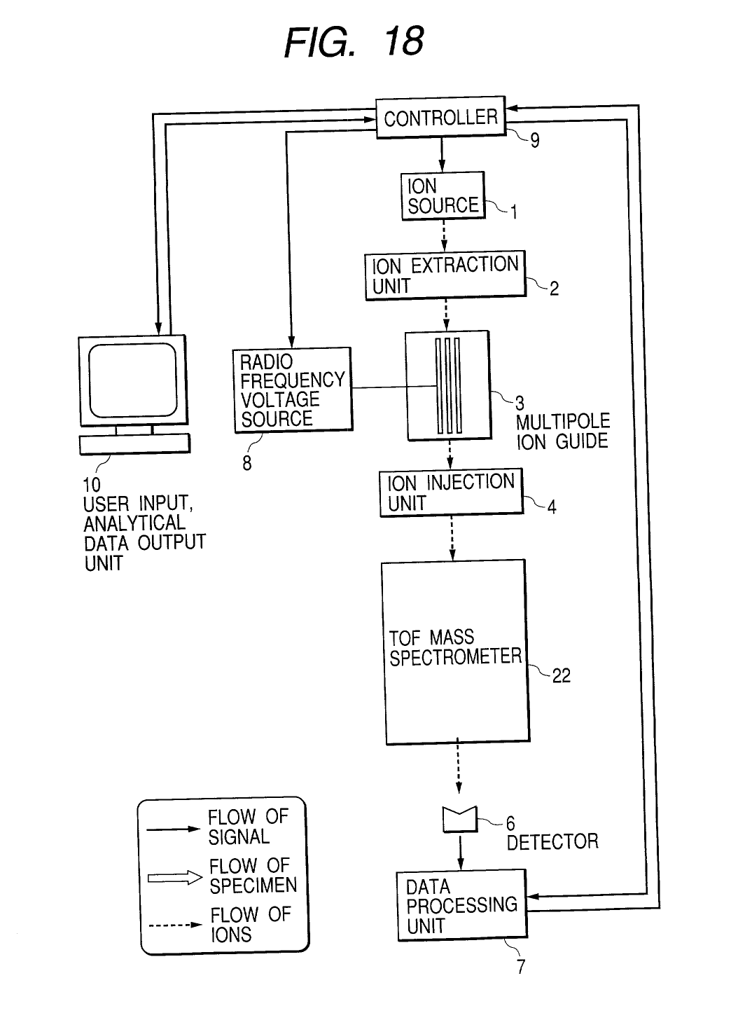

Further, as a mass spectrometer of a type of analyzing ions ionized outside the mass spectrometer 5, there are additionally a quadrupole mass spectrometer 21 as shown in FIG. 17 and a TOF type mass spectrometer 22 as shown in FIG. 18 available.

The aforementioned mass spectrometers are also a mass spectrometer of a type of analyzing ions ionized outside the mass spectrometer 5, so that an ion transport unit such as a multipole ion guide is necessary. When the multipole ion guide 3 is adopted as an ion transport unit, under each aforementioned control, specimen ions which are an object of mass spectrometric analysis can be transported stably to the mass spectrometer 5, so that highly sensitive analysis can be expected regardless of the kind of a mass spectrometer.

### Industrial Field of Utilization

### Effects of the Invention

As explained above, according to the present invention, in the mass spectrometer adopting the multipole ion guide as a means for transporting ions generated by the ion source to the mass spectrometer, necessary ions pass highly efficiently, and unwanted ions which are a noise source can be eliminated before arriving at the mass spectrometer, and low-noise and highly-sensitive analysis can be realized at a low cost.

What is claimed is

1. A mass spectrometer having an ion source for ionizing a specimen, an ion transport system using a multipole radio frequency electric field more than a quadrupole electric field as transport means for transporting said ions, an ion injection unit for injecting said ions passing through said transport system into a mass spectrometer, a mass spectrometer for separating and analyzing said ions according to a mass-to-charge ratio of said ions, and a detector for detecting said ions analyzed mass-spectrometrically, wherein:
said mass spectrometer has control means for changing said multipole electric field of radio frequency generated in said transport system according to said mass-to-charge ratio of said ions passing through said transport system.

2. A mass spectrometer according to claim 1, wherein:
said transport system has four or more rod-shaped electrodes, applies a radio frequency voltage Vₘᵤₗcos (Ωₘᵤₗt) to said rod-shaped electrodes so that a sign of a voltage to be applied to each adjacent rod-shaped electrode is inverted, thereby generates said multipole radio frequency electric field more than a quadrupole electric field, and transports said ions and
said control means has a function for controlling at least one of a voltage amplitude Vₘᵤₗ of said radio frequency and a frequency Ωₘᵤₗt/2π according to said mass-to-charge ratio of said ions passing through said transport system, thereby changing said multipole electric field of said transport system.

3. A mass spectrometer according to claim 2, wherein said control means has a function for changing said multipole electric field so that, when a parameter q value of said ions passing through said transport system is defined by a following formula:
[Formula 1]
q=4eZVₘᵤₗ/(mrₒ²Ωₘᵤₗ²)
(where e is an elementary charge, and rₒ is a half value of a distance between opposite rod electrodes, and m/Z is a mass-to-charge ratio of ions, and Ωₘᵤₗ is an angular frequency of said radio frequency voltage to be applied to said ion transport system,)
said q value is changed according to said mass-to-charge ratio of said ions passing through said transport system.

4. A mass spectrometer according to claim 2, wherein said control means has a function for changing said multipole electric field so that said q value is reduced to a specific value or smaller according to said mass-to-charge ratio of said ions passing through said transport system.

5. A mass spectrometer according to claim 4, wherein said specific value or smaller is 1.5 or smaller.

6. A mass spectrometer according to claim 4, wherein said control means has a function for changing said multipole electric field so that a parameter q value of said ions having a smallest mass-to-charge ratio among said ions having said mass-to-charge ratio within a specific range passing through said transport system.

7. A mass spectrometer according to claim 3, wherein said control means has a function for changing said multipole electric field in said transport system so that in correspondence to a mass-to-charge ratio of unwanted ions which are not an object of mass spectrometric analysis, a parameter q value of said unwanted ions is increased to a specific value or larger.

8. A mass spectrometer according to claim 3, wherein said control means has a function for scanning by interlocking with at least one of said voltage amplitude Vₘᵤₗ of said radio frequency to be applied to said transport system and said frequency Ωₘᵤₗt/2π so that when said ions having said mass-to-charge ratio within a specific range are to be scanned and mass spectrometric analysis is to be executed in said mass spectrometer, a parameter q value of said ions of each mass-to-charge ratio of a scanning object is kept constant.

9. A mass spectrometer according to claim 3, wherein said control means has a function for, when said ions having said mass-to-charge ratio within a specific range are to be scanned and mass spectrometric analysis is to be executed in said mass spectrometer, so as to keep a parameter q value of said ions of each mass-to-charge ratio of a scanning object constant, changing said multipole electric field generated in said transport unit, executing said scanning several times, and changing said constant value of said parameter for each scanning and
executing at least one of, as means for processing analytical data, (1) obtaining a mean value of mass spectrometric analytical data obtained by several times of mass spectrometric analysis scanning, or (2) when data at a time of mass spectrometric analysis scanning when a certain specific q value is set is highly sensitive peculiarly, only said data is adopted as mass spectrometric analytical data, or (3) when said data at a time of mass spectrometric analysis scanning when a certain specific q value is set is lowly sensitive particularly, a statistical process is performed excluding said mass spectrometric analytical data.

10. A mass spectrometer according to claim 1, wherein said mass spectrometer is one of an ion trap type mass spectrometer, a quadrupole mass spectrometer, and a time of flight mass spectrometer.
